(19) United States
(12) Patent Application Publication
(10) Pub. No.: US 2011/0075284 A1
(43) Pub. Date: Mar. 31, 2011

(54) Infinite progression mirror box

(75) Inventor: Steven Roger Brandon, Tucson, AZ (US)

(73) Assignee: Steven Roger Brandon, Tucson, AZ (US)

(21) Appl. No.: 12/586,910

(22) Filed: Sep. 30, 2009

(51) Int. Cl. G02B 5/08

(52) U.S. Cl. 359/856

(57) ABSTRACT

This device uses mirrors and the optical effect of parallax to create the optical illusion of an infinite regression of reflections in those mirrors. Mirrors are attached, facing inwards, to the four inner sides of a box, and a mirror is attached to the bottom facing upwards. Mirrors that reflect on one side but can be seen through when looking from the other side are generally known as “see through” or “one way” mirrors. The front side of the box has viewing portals and a one way “see through” mirror through which the viewer can look directly from outside the box into the line of sight for the reflections inside the box without the viewer's reflection showing in the mirrors. Thus, the viewer sees a nearly infinite chain of reflections in the mirrors because of the optical effect of parallax and because the viewer's reflection is in spite of the fact that the viewer is looking directly into a mirror because the viewer's reflection is hidden by the “one way” see through mirror in the front.

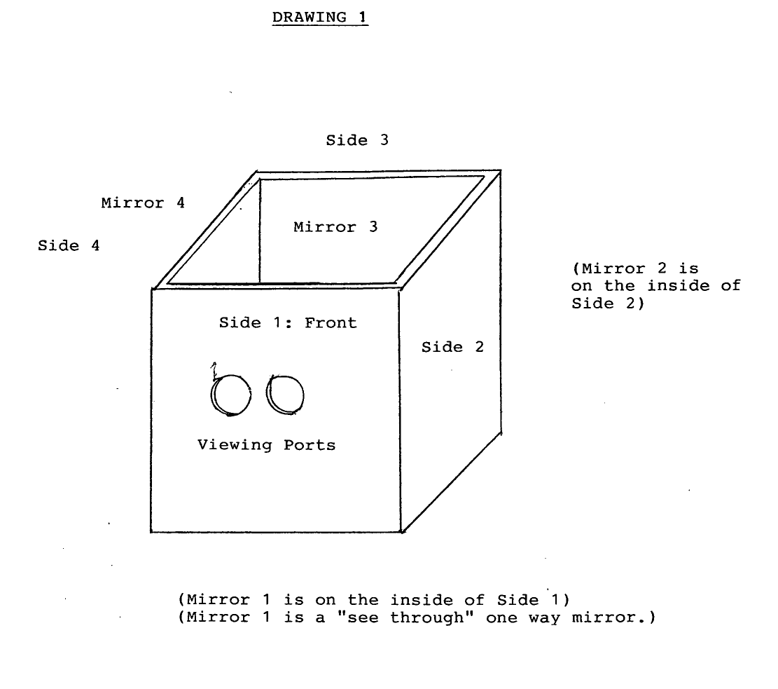

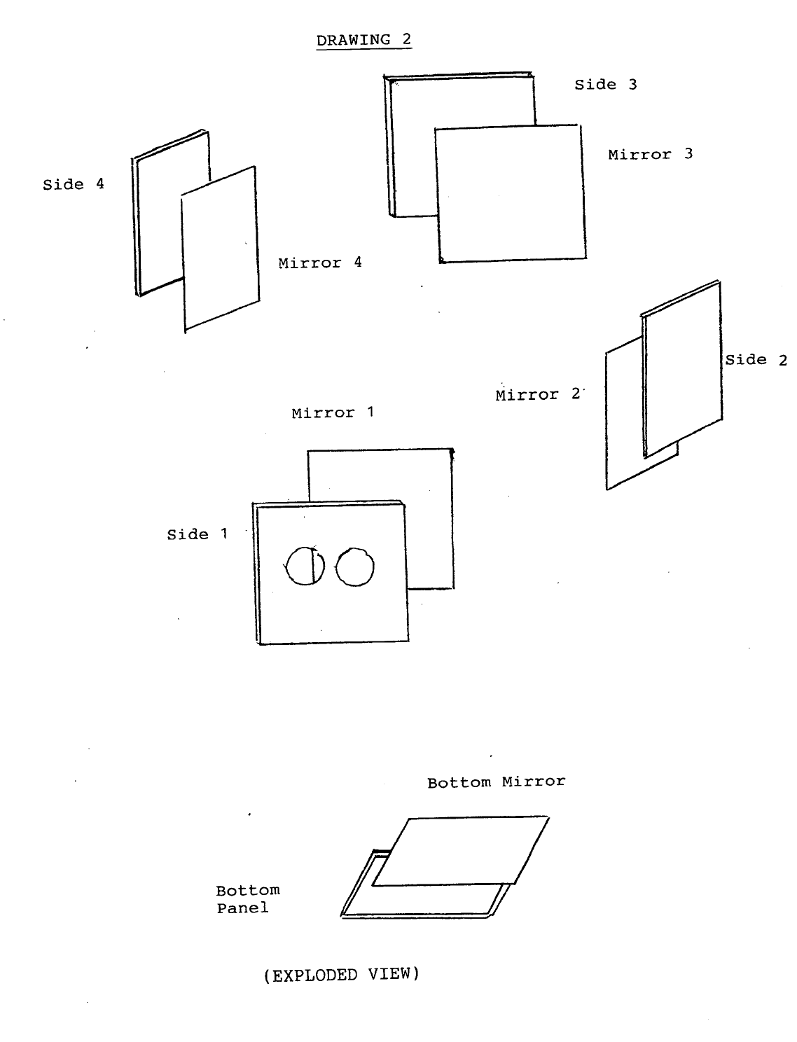

Mirrors reflect the light from objects put in front of them. If two mirrors are placed parallel to and directly in front of each other, the light will reflect in a manner that is perpendicular to the parallel mirrors, creating an almost infinite view of mirrors reflecting themselves in each mirror. This effect can generally be described as “parallax.” Prior to this invention, the only way to view the infinite regression of parallel light rays running perpendicular to and reflected in the mirrors was for the viewer to use large enough mirrors to interpose the viewer between the mirrors while still maintaining a large enough space in the mirrors so as to allow the viewer's reflection to only partially obstruct the viewer's view of the infinite regression of reflecting mirrors. This device solves the problem of the viewer's own reflection obstructing the view of the infinite regression of reflections by employing a “see through” “one way” mirror, which allows the viewer to stand outside the parallel mirrors, rather being inside, to view the infinite regression of reflections, eliminating the viewer's own reflection from obstructing the view of the mirrors reflecting each other. Hence, the viewer has a clean, unobstructed view of the infinite regression of parallel and perpendicular mirrors because the viewer is outside, rather than inside, the infinite chain of reflections. The chain of mirrors reflected is limited only by the size and distance of the mirrors involved, variables I specifically reserve and claim to the right to keep as an open option as part of this patent claim.

### BRIEF DESCRIPTION OF DRAWINGS

Drawing 1

a.) Side 1 contains the viewing portal holes on the front side and the “see through” “one way” mirror attached to the back.

b.) Side 1 contains the only viewing portal holes.

c.) Side 1 contains the only “see through” “one way” mirror.

d.) The other three mirrors, Mirrors 2, 3, 4, and the mirror on the bottom facing upwards, are all regular mirrors.

Drawing 2

a.) This drawing is an “exploded view” of the mirror box showing the individual parts of the box.

b.) Note that Mirror 1 does not have viewing holes in it. This is because Mirror 1 is the “see through” “one way” mirror and the viewer looks directly through the mirrored glass. The small size of the viewing portals allows the viewer to look through the backside of the mirror without being reflected in the opposite mirror.

I claim:

1. A cubed box with mirrors on the four inner sides facing inwards and a mirror on the bottom facing upwards.
The cubed box of claim 1 is open on top to allow light into the box and for viewing from the open top.
The cubed box of claim 1 wherein the front side contains a viewing portal consisting of two holes.
The viewing portal in claim 3 of the cubed box of claim 1 wherein the two holes of the viewing portal are of a such a size and distance no greater but no less than the average human eyes so that any adult may comfortably look through the portals without obstruction or need.
The cubed box of claim 1 wherein the inside of the front side, which contains the viewing portals of claim 3, contains a “see through” “one way” mirror, facing inwards into the mirror box such that its reflection is reflected in the other mirrors of the cubed box.
The “see through” “one way” mirror of claim 5 wherein the reflective side is faced inwards and the “see through” side is facing the viewing portal holes of claim 3.
The cubed box of claim 1 wherein the 3 sides other than the front side all contain “normal” mirrors attached to the sides of the cubed box and facing inwards.
The viewing portal holes of claim 3 wherein the “see through” “one way” mirror of claim 5 is affixed to the inside of the front side containing the viewing portal holes such that the viewer looks through the holes and the backside of the “see through” “one way” mirror and sees an infinite regression of reflections of the “empty” “see through” “one way” mirror in the regular mirrors of the other 3 sides of the cubed box of claim 1.
The “see through” “one way” mirror of claim 5 wherein the affixing the mirror to a solid surface on the inside of the front side of the cubed box of claim 1 such that the solid surface surrounding the viewing portals and the small size of the viewing portals themselves restricts the entry of light to the back side of the “see through” “one way” mirror so that the viewer's reflection does not show in the opposite mirror when the viewer is looking directly through the viewing portal holes of claim 3.
